(19) United States
(12) Patent Application Publication
(10) Pub. No.: US 2007/0190375 A1
(43) Pub. Date: Aug. 16, 2007

(54) Catalyst for oxidizing carbon monoxide for reformer used in fuel cell, method of preparing same, and fuel cell system including same

(76) Inventor: Leonid Gorobinskiy, Suwon-si (KR)

Correspondence Address: Robert E. Bushnell;Suite 300, 1522 K Street, N.W., Washington, DC, 20005-1202, US

(21) Appl. No.: 11/651,460

(22) Filed: Jan. 10, 2007

(30) Foreign Application Priority Data
Feb. 14, 2006 (KR) 10-2006-0014072

(51) Int. Cl. H01M 8/06; H01M 8/18; B01J 23/00

(52) U.S. Cl. 429/20; 502/304; 502/345; 502/325

(57) ABSTRACT

In a fuel cell, a fuel cell system, and a method of preparing the same, a carbon monoxide oxidizing catalyst for a reformer of the fuel cell system includes: a carrier selected from the group consisting of alumina, cordierite, and combinations thereof; and an active material including CeO₂, MO, and CuO, where M is a transition element which is supported on the carrier.

### CLAIM OF PRIORITY

This application makes reference to, incorporates the same herein, and claims all benefits accruing under 35 U.S.C.§119 from an application for CATALYST FOR OXIDIZING CARBON MONOXIDE FOR REFORMER USED IN FUEL CELL, METHOD OF PREPARING SAME, AND FUEL CELL SYSTEM INCLUDING SAME earlier filed in the Korean Intellectual Property Office on the Feb. 14, 2006 and there duly assigned Serial No. 10-2006-0014072.

### BACKGROUND OF THE INVENTION

1. Technical Field

The present invention relates to a carbon monoxide oxidizing catalyst for a reformer of a fuel cell system, a method of preparing the same, and a fuel cell system including the same. More particularly, the present invention relates to a carbon monoxide oxidizing catalyst having carbon monoxide oxidation efficiency for a reformer of a fuel cell system, a method of preparing the same, and a fuel cell system including the same.

2. Related Art

A fuel cell is a power generation system for producing electrical energy through an electrochemical redox reaction of an oxidant and a fuel, such as hydrogen, or a hydrocarbon-based material, such as methanol, ethanol, natural gas, and the like.

Such a fuel cell is a clean energy source which can replace fossil fuels. It includes a stack composed of unit cells and produces various ranges of power output. Since it has four to ten times higher energy density than a small lithium battery, it has been highlighted as a small portable power source.

Representative exemplary fuel cells include a polymer electrolyte membrane fuel cell (PEMFC) and a direct oxidation fuel cell (DOFC). Direct oxidation fuel cells include a direct methanol fuel cell which uses methanol as a fuel.

The polymer electrolyte fuel cell has the advantages of high energy density and high power, but it also has problems in that there is a need to carefully handle hydrogen gas, and there is a requirement for accessory facilities, such as a fuel reforming processor for reforming methane or methanol, natural gas and the like, in order to produce hydrogen as the fuel gas.

Conversely, a direct oxidation fuel cell has lower energy density than that of the polymer electrolyte fuel cell, but it has the advantages of easy handling of the polymer electrolyte fuel cell, a low operation temperature, and no need for additional fuel reforming processors.

In the above-mentioned fuel cell system, a stack that generates electricity substantially includes several to scores of unit cells stacked adjacent to one another, and each unit cell is formed of a membrane-electrode assembly (MEA) and a separator (also referred to as a bipolar plate). The membrane-electrode assembly is composed of an anode (also referred to as a “fuel electrode” or an “oxidation electrode”) and a cathode (also referred to as an “air electrode” or a “reduction electrode”) which are separated by a polymer electrolyte membrane.

A fuel is supplied to the anode and adsorbed on catalysts of the anode, and the fuel is oxidized to produce protons and electrons. The electrons are transferred into the cathode via an external circuit, and the protons are transferred into the cathode through the polymer electrolyte membrane. In addition, an oxidant is supplied to the cathode, and then the oxidant, protons and electrons are reacted on catalysts of the cathode to produce electricity along with water.

A fuel cell system is composed of a stack, a reformer, a fuel tank, and a fuel pump. The stack forms a body of the fuel cell system, and the fuel pump provides the fuel stored in the fuel tank to the reformer. The reformer reforms the fuel to generate the hydrogen gas and supplies the hydrogen gas to the stack.

A reformer of a general fuel cell system comprises a reforming reaction part which generates hydrogen gas from a fuel through a catalyst reforming reaction using heat energy, and a carbon monoxide reducing part which reduces a carbon monoxide concentration in the hydrogen gas through an oxidation reaction of the hydrogen gas with oxygen. Such a reforming reaction is performed by a reforming catalyst, and therefore there are many researches into a reforming catalyst.

### SUMMARY OF THE INVENTION

One embodiment of the present invention provides a carbon monoxide oxidizing catalyst having excellent carbon monoxide oxidation efficiency for a reformer of a fuel cell system.

Another embodiment of the present invention provides a method for preparing the carbon monoxide oxidizing catalyst.

A further embodiment of the present invention provides a membrane-electrode assembly for a fuel cell including the carbon monoxide oxidizing catalyst.

An embodiment of the present invention provides a carbon monoxide oxidizing catalyst for a reformer of a fuel cell system which includes: a carrier selected from the group consisting of alumina, cordierite, and combinations thereof; and an active material including CeO₂, MO, and CuO, where M is a transition element which is supported on the carrier. M is selected from the group consisting of Ni, Co, Fe, and combinations thereof. According to an embodiment, Ni, Fe, or combinations thereof are included in the catalyst.

According to another embodiment of the present invention, a method of preparing a carbon monoxide oxidizing catalyst comprises: mixing alumina or cordierite with a cerium compound solution; adding the mixture to a transition element compound solution; subjecting the mixture, including the alumina or cordierite, the cerium compound, and the transition element compound, to a first calcination; adding a Cu compound solution to the calcinated product; and subjecting the mixture to a second calcination.

According to a further embodiment of the present invention, a fuel cell system comprises: a reformer including a reforming reaction part which generates hydrogen gas from a fuel through a catalyst reforming reaction using heat energy, and a carbon monoxide reducing part which reduces a carbon monoxide concentration in the hydrogen gas through an oxidation reaction of the hydrogen gas with an oxidant; at least one electricity generating element for generating electrical energy by electrochemical reactions of the hydrogen gas and oxygen; a fuel supplier for supplying the fuel to the reforming reaction part; an oxidant supplier for supplying the oxidant to the carbon monoxide reduction part and the electricity generating element, respectively; and a cooler for cooling heat generated from the carbon monoxide reduction part by circulating the fuel supplied to the reforming reaction part to the carbon monoxide reduction part. The reformer includes the above carbon monoxide oxidizing catalyst.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic diagram showing the structure of a fuel cell system according to an embodiment of the present invention.

FIG. 2 is a temperature profile graph during the calcination process according to Example 3 of the present invention.

FIG. 3 shows a reactor used for the preferential oxidation (PROX) reaction using the catalysts according to Examples 3 thru 5 of the present invention and Comparative Example 1.

FIG. 4 shows the measurement results of released CO amounts during the PROX reaction using the catalysts according to Examples 3 thru 5 of the present invention and Comparative Example 1.

### DETAILED DESCRIPTION OF THE INVENTION

Exemplary embodiments of the present invention will hereinafter be described in detail with reference to the accompanying drawings.

According to one embodiment of the present invention, a carbon monoxide oxidizing catalyst for a reformer of a fuel cell system is provided.

A fuel cell system generally includes an electricity generating element and a fuel supplier, where a polymer electrolyte fuel cell of the fuel cell system includes a reformer for generating hydrogen gas from reforming the fuel.

The reformer includes a reforming reaction part for generating hydrogen gas from the fuel through a catalyst reforming reaction by heat energy, and a carbon monoxide reduction part for reducing the concentration of carbon monoxide included in the hydrogen gas through an oxidation reaction of hydrogen gas with an oxidant.

In the carbon monoxide reduction part, a preferential oxidation (PROX) is performed. Through the preferential oxidation, the carbon monoxide content included as impurities is reduced to a ppm level. It is necessary to reduce the carbon monoxide content since it poisons fuel cell catalysts, thereby deteriorating electrode performance.

Platinum-based metals such as Pt, Rh, Ru, and so on are used for a conventional preferential oxidation process. However, these metals have high cost and low selectivity. Recently, transition element catalysts have been researched. For example, it is suggested that a Cu—Ce mixed catalyst has improved CO oxidation reaction activity compared to a Cu catalyst.

However, there is still a need for improvement of CO oxidation reaction activity.

According to one embodiment of the present invention, a transition element is included in a Cu—Ce catalyst to improve catalyst activity.

The carbon monoxide oxidizing catalyst for a reformer of a fuel cell system according to one embodiment includes: a carrier selected from the group consisting of alumina, cordierite, and combinations thereof; and an active material including CeO₂, MO, and CuO supported on the carrier. Herein, M is a transition element such as Ni, Co, Fe, or combinations thereof. According to another embodiment, Ni, Fe, or combinations thereof may be included in the MO. According to another embodiment, the MO is nickel oxide. When comparing NiO with CoO, NiO is smaller and also chemically and structurally more stable than CoO, and therefore NiO is not changed to another phase to effectively oxidize carbon monoxide during fuel reforming reaction. In this regard, NiO is better than CoO as a catalyst to prevent catalyst poisoning by carbon monoxide.

Herein, the amount of MO included in the carbon monoxide oxidizing catalyst ranges from 0.1 to 2 wt %. According to another embodiment, the amount ranges from 0.1 to 0.4 wt %. When the amount of MO is less than 0.1 wt %, the effect of including MO is insufficient, but when the amount is more than 2 wt %, the activity thereof is deteriorated.

Furthermore, the carbon monoxide oxidizing catalyst includes 10 to 30 wt % of CeO₂. According to another embodiment, it includes 15 to 25 wt % of CeO₂. The carbon monoxide oxidizing catalyst includes 1 to 10 wt % of CuO. According to another embodiment, it includes 2.5 to 5 wt % of CuO. When the amount of CeO₂ is less than 10 wt %, the oxygen diffusion concentration is too low, but when the amount is more than 30 wt %, the pore structure and thermal stability are remarkably deteriorated.

Herein, the carbon monoxide oxidizing catalyst has a pore structure. According to another embodiment, the porosity S_{BET} thereof ranges from 200 to 300 m²/g. When the porosity S_{BET} is less than 200 m²/g, the reactant is insufficiently transferred into the surface of the catalyst, but when it is more than 300 m²/g, the obtained catalyst is physically unstable and brittle.

According to an embodiment, the carrier includes cordierite which is reformed to alumina. The method for reforming to alumina is well known to those skilled in the art, and thus a detailed description is omitted, and it is simply described as follows.

An alumina compound, such as alumina nitrate, is dissolved in water in the amount of 1 to 10 wt % to provide an alumina solution. Herein, according to another embodiment, the alumina compound may be included in the amount of 2 to 5 wt %. Subsequently, cordierite is immersed in the alumina solution and dried at 120±10° C., this process being repeated 3 to 5 times. The amount of cordierite immersed in the alumina solution ranges from 5 to 20 wt %. According to another embodiment, the amount ranges from 10 to 15 wt %.

The carbon monoxide oxidizing catalyst may further include additives, such as Cu, Au, Ru, Pt, Na, Ca, K, or a mixture thereof. Among them, Cu, Au, Ru, and Pt may form an active site on the surface of the catalyst. The adding amount of the elements may range from 0.1 to 3 parts by weight based on 100 parts by weight of the carbon monoxide oxidizing catalyst. When the adding amount of the elements is less than 0.1 parts by weight, the active site is insufficient, but when it is more than 3 parts by weight, the metal cluster is too large to produce water as a side-product.

Furthermore, when Na, Ca, or K is interposed in the CeO₂ structure, it may form defects that increase activity. The elements may be added in 0.001 to 1 parts by weight based on 100 parts by weight of the carbon monoxide oxidizing catalyst. According to another embodiment, the amount ranges from 0.1 to 0.5 parts by weight. When the elements are added in less than 0.001 parts by weight, the effects are insufficient. On the other hand, when they are added in more than 1 parts by weight, they form an excess of defects, thereby deteriorating the oxygen diffusion.

The carbon monoxide oxidizing catalyst may be prepared by various techniques. Two procedures will be illustrated in some detail, but the invention is not limited to them.

One of the procedures is as follows:

Firstly, alumina or cordierite is mixed with a cerium compound solution.

Herein, the mixture ratio of alumina or cordierite and the cerium compound ranges from 50 to 90 wt % or 10 to 50 wt %. According to another embodiment, it may range from 80 to 75 wt % or 20 to 25 wt %. When the cerium compound is added in more than 50 wt %, it may provide a bulk cerium oxide having a low specific surface area, thereby deteriorating the pore structure. When it is added in less than 10 wt %, the cerium oxide is insufficiently incorporated in the surface of the alumina or cordierite so that oxygen vacancy is not fully formed, thereby decreasing the oxygen diffusion.

The cerium-containing compound may be ammonium cerium nitrate, cerium nitrate, cerium acetate, cerium chloride, or a mixture thereof. The cerium compound may be used in the form of a hydrate.

The cerium-containing compound may include a solvent of water.

The obtained mixture is added to a transition element-containing compound solution.

The transition element-containing compound solution may be added to provide a transition element compound of 0.1 to 10 parts by weight based on 100 parts by weight of cerium compound. According to another embodiment, it may range from 0.1 to 4 parts by weight. When the adding amount of the transition element compound solution is more than 10 parts by weight, it is not impregnated, and when it is less than 0.1 parts by weight, the transition element compound is not sufficiently supported, and so the process should be repeated.

The transition element-containing compound may include a nitrate, an acetate, or a chloride, and representative examples thereof include Ni(NO₃)₂.6H₂O, Ni(OCOCH₃)₂, or NiCl₂. The transition element-containing compound may be used in the form of a hydrate.

The transition element compound solution may include a solvent of water.

In the adding process, Cu, Au, Ru, Pt, Na, Ca, K, or a mixture thereof may be further added.

The obtained mixture is calcinated. The calcination process may be performed at 450 to 550° C. When the calcination process is performed at less than 450° C., the CeO₂ forming reaction is delayed, but when it is performed at more than 550° C., the pore structure is damaged.

To the calcinated product, a Cu compound solution may be added in 1 to 10 parts by weight based on 100 parts by weight of cerium compound. According to another embodiment, the adding amount of the Cu compound solution ranges from 2.5 to 5 parts by weight. When the Cu compound solution is less than 1 wt %, the supported Cu is insufficient so that the process needs to be repeated several times. On the other hand, when it is more than 10 wt %, Cu is not uniformly supported on the carrier.

The Cu salt may include a nitrate or an acetate, and representative examples thereof include Cu(NO₃)₂ or Cu(OCOCH₃). The copper compound may be used in the form of a hydrate.

The Cu salt solution may include a solvent of water.

Then, the obtained mixture is calcinated. The calcination process may be performed at 450 to 550° C. When the calcination process is performed at less than 450° C., the solid reactant is insufficiently diffused and the copper does not reach the active site so that it is hard to provide an active copper. On the other hand, when it is performed at more than 550° C., the surface is reduced and the pore size is decreased, and it also blocks the transmission of the gas reactant into the active site of the catalyst surface.

Another procedure is as follows:

A Cu compound solution is mixed with a transition element-containing compound solution. The mixture is mixed with a cerium-containing compound. In the adding process, Cu, Au, Ru, Pt, Na, Ca, K, or a mixture thereof may be further added.

The Cu compound solution, the transition element-containing compound solution, and the cerium-containing compound may be the above Cu compound solution, the transition element-containing compound solution, and the cerium-containing compound.

The resulting mixture is mixed alumina or cordierite, and the obtained mixture is calcinated. The calcination process may be performed at 450 to 550° C. When the calcination process is performed at less than 450° C., the solid reactant is insufficiently diffused and the copper does not reach the active site so that it is hard to provide an active copper. On the other hand, when it is performed at more than 550° C., the surface is reduced and the pore size is decreased, and it also blocks the transmission of the gas reactant into the active site of the catalyst surface.

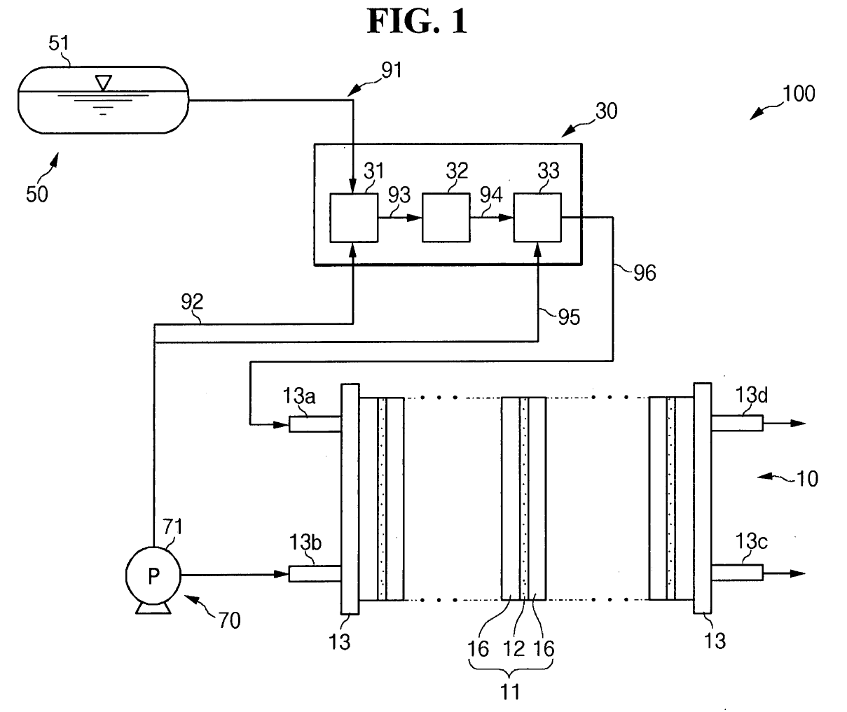

As the carbon monoxide oxidizing catalyst is used in a fuel cell system, the fuel cell system will be described with reference to FIG. 1, which is a schematic diagram showing the structure of a fuel cell system according to an embodiment of the present invention.

As shown in FIG. 1, the fuel cell system 100 comprises: a stack 10 including an electricity generating element 11 which generates electrical energy through electrochemical reactions; a reformer 30 which generates hydrogen gas from a liquid fuel and supplies the hydrogen gas; a fuel supplier 50 for supplying a fuel to the reformer 30; and an oxidant supplier 70 for supplying an oxidant to the reformer 30 and the stack 10, respectively.

The electricity generating element 11 is formed as a minimum unit for generating electricity by disposing a membrane-electrode assembly (MEA) 12 between two separators 16, and then a stack 10 is formed with a stacked structure by arranging a plurality of minimum units. The membrane-electrode assembly 12 includes an anode and a cathode, and performs hydrogen gas oxidation and oxygen reduction reactions. The separators 16 supply hydrogen gas and oxidant through gas passage paths formed at both sides of the membrane-electrode assembly 12, and also function as conductors connecting the anode and the cathode in series.

The stack 10 can additionally include pressing plates 13 for positioning a plurality of the electricity generating elements 11 closely adjacent to each other at the outermost ends of the stack 10. However, the stack 10 of a fuel cell according to the present embodiment can be formed by positioning separators 16 at the outermost ends of the electricity generating elements 11 so as to play a role in pressing the electricity generating elements 11 instead of using the separate pressing plates 13. Conversely, the pressing plates 13 can be formed so as to intrinsically function as the separators 16 in addition to closely arranging the plurality of electricity generating elements 11.

The pressing plates 13 include a first inlet 13a to supply hydrogen gas to the electricity generating elements 11, a second inlet 13b to supply oxidant to the electricity generating elements 11 from the oxidant supplier 40, a first outlet 13c to release hydrogen gas remaining after a reaction at the anodes of the membrane-electrode assemblies 12, and a second outlet 13d to release non-reacted air including moisture generated through a reduction reaction of the oxidant at the cathodes of the membrane-electrode assemblies 12.

The reformer 30 has a structure for generating hydrogen gas from a fuel by chemical catalytic reactions using heat energy and for reducing carbon monoxide concentration in the hydrogen gas.

The reformer 30 includes a heating source 31 for commonly generating heat energy through a catalytic oxidation reaction of the fuel and the oxidant, a reforming reaction part 32 for generating hydrogen gas from the fuel through a steam reforming (SR) catalyst reaction by the heat energy, and a carbon monoxide reduction part 33 for reducing the concentration of carbon monoxide included in the hydrogen gas.

In the present invention, the reaction of the reformer 30 is not limited to the steam reforming catalyst reaction, and may include an auto-thermal reforming (ATR) reaction or partial oxidation (POX) without the use of the heating source 31.

The heating source 31 is connected to a fuel tank 51 through a first supply line 91 having a pipe shape, and is connected to an oxidant pump 71 through a second supply line 92 having a pipe shape. The liquid fuel and oxidant pass through the heating source 31. The heating source 31 includes a catalyst layer (not shown) which accelerates the oxidation reaction of the fuel with the oxidant to generate the heat energy. Herein, the heating source 31 is formed as a plate which provides a channel (not shown) capable of inflowing the liquid fuel and the oxidant. The surface of the channel is coated with the catalyst layer. The heating source 31 is shaped as a cylinder which has a predetermined internal space. The internal space may be filled with a catalyst layer, such as a pellet type catalyst module or a honey comb type catalyst module.

The reforming reaction part 32 absorbs the heat energy generated from the heating source 31 so as to generate the hydrogen gas from the fuel through the steam-reforming catalyst reforming reaction of the fuel supplied from the fuel tank 51. The reforming reaction part 32 is directly connected to the heating source 31 via a third supply line 93. In addition, the reforming reaction part 32 includes a catalyst layer (not shown) for generating the hydrogen gas by accelerating the steam reforming reaction of the fuel. Herein, the reforming reaction part 32 includes a channel (not shown) capable of inflowing the fuel. The surface of the channel is coated with a catalyst layer. The reforming reaction part 32 is shaped as a cylinder which has a predetermined internal space. The internal space may be filled with a catalyst layer, such as a pellet type catalyst module or a honey comb type catalyst module.

The carbon monoxide reduction part 33 reduces carbon monoxide concentration in the hydrogen gas through a preferential CO oxidation catalyst reaction of the hydrogen gas with air. The hydrogen gas is generated from the reformer reaction part 32 and the air is supplied from the oxidant pump 71. The carbon monoxide reduction part 33 is connected to the reformer reaction part 32 via a fourth supply line 94, and to the oxidant pump 71 via a fifth supply line 95. Thus, the hydrogen gas and the oxidant pass through the carbon monoxide reduction part 33. The carbon monoxide reduction part 33 may include a catalyst layer (not shown) which includes a catalyst. The catalyst accelerates the preferential oxidation reaction to reduce the carbon monoxide concentration included in the hydrogen gas. Herein, the carbon monoxide reduction part 33 includes a channel (not shown) capable of inflowing the fuel. The surface of the channel is coated with the catalyst layer. The carbon monoxide reduction part 33 is shaped as a cylinder which has a predetermined internal space. The internal space may be filled with a catalyst layer, such as a pellet type catalyst module or a honey comb type catalyst module.

Herein, the carbon monoxide reduction part 33 is connected to the first inlet 13a of the stack 10 via a sixth supply line 96. The carbon monoxide reduction part 33 provides the electricity generating elements 11 of the stack 10 with the hydrogen gas in which the carbon monoxide concentration is reduced by the carbon monoxide reduction part 33. In addition, the carbon monoxide reduction part 33 may be formed of thermal conductive stainless steel, aluminum, copper, iron, or the like.

The membrane-electrode assembly, which constitutes the electricity generating element of the above fuel cell system, includes a cathode and an anode, and a polymer electrolyte membrane interposed between the cathode and anode.

The cathode and the anode each include an electrode substrate and a catalyst layer.

The catalyst layer includes a platinum-based catalyst selected from the group consisting of platinum, ruthenium, osmium, platinum-ruthenium alloys, platinum-osmium alloys, platinum-palladium alloys, platinum-M alloys (where M is a transition element selected from the group consisting of Ga, Ti, V, Cr, Mn, Fe, Co, Ni, Cu, Zn, Sn, Mo, W, Rh, Ru, and combinations thereof), and combinations thereof. More specifically, non-limiting examples of the platinum-based catalyst are selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

Such a metal catalyst may be used in the form of a metal itself (black catalyst), or one supported on a carrier. The carrier may include carbon such as graphite, denka black, ketjen black, acetylene black, carbon nanotubes, carbon nanofiber, carbon nanowire, carbon nanoballs, or activated carbon, or an inorganic particulate such as alumina, silica, zirconia, or titania. Carbon is generally used. When the catalyst includes a noble metal supported on a carrier, it may include any one available in the market or one prepared by carrying a noble metal on a carrier. The process for supporting a noble metal on a carrier is well known to those having skill in the art, and thus more details will not described herein.

The catalyst layer may further include a binder resin to improve its adherence and proton transference.

The binder resin may be a proton conductive polymer resin having a cation exchange group selected from the group consisting of a sulfonic acid group, a carboxylic acid group, a phosphoric acid group, a phosphonic acid group, and derivatives thereof, at its side chain. Non-limiting examples of the polymer include at least one proton conductive polymer selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

The H can be replaced with Na, K, Li, Cs, or tetrabutylammonium in a proton conductive group of the proton conductive polymer. When the H is replaced with Na in an ion exchange group at the terminal end of the proton conductive group, NaOH is used. When the H is replaced with tetrabutylammonium, tetrabutylammonium hydroxide is used. K, Li, or Cs can also be replaced by using appropriate compounds. A method of replacing H is known in this art, and therefore is not described in detail.

The binder resin may be used singularly or as a mixture. Optionally, the binder resin may be used along with a non-conductive polymer to further improve adherence strength between a polymer electrolyte membrane and the catalyst layer. The amount of the binder resin used may be adjusted to its usage purpose.

Non-limiting examples of the non-conductive polymer include polytetrafluoroethylene (PTFE), tetrafluoroethylene-hexafluoropropylene copolymers (FEP), tetrafluoroethylene-perfluoro alkyl vinylether copolymers (PFA), ethylene/tetrafluoroethylene (ETFE)), ethylenechlorotrifluoro-ethylene copolymers (ECTFE), polyvinylidene fluoride, polyvinylidene fluoride-hexafluoropropylene copolymers (PVdF-HFP), dodecyl benzene sulfonic acid, sorbitol, and combinations thereof.

The electrode substrate supports the electrode, and provides a path for diffusing and transferring fuel and an oxidant to the catalyst layer. In one embodiment, the electrode substrate is formed from a material such as carbon paper, carbon cloth or carbon felt, or a metal cloth which includes a metal film formed on a surface of a porous cloth film or a cloth composed of polymer fibers, but the electrode substrate is not limited thereto.

The electrode substrate may include water-repellent fluoro-based resins to prevent the deterioration of diffusion efficiency due to the water generated during the operation of a fuel cell. The fluoro-based resin may include polytetrafluoroethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, or a copolymer thereof.

A microporous layer (MPL) can be added between the aforementioned electrode substrate and catalyst layer to increase reactant diffusion effects. The microporous layer generally includes conductive powders with a certain particle diameter. The conductive material may include, but is not limited to, carbon powder, carbon black, acetylene black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the electrode substrate. The binder resin may include, but is not limited to, polytetrafluoroethylene, polyvinylidenefluoride, polyhexafluoropropylene, polyperfluoroalkylvinylether, polyperfluorosulfonylfluoride, alkoxyvinyl ether, polyvinylalcohol, cellulose acetate, or copolymers thereof. The solvent may include, but is not limited to, an alcohol such as ethanol, isopropylalcohol, n-propylalcohol, butanol, and so on, water, dimethylacetamide, dimethylsulfoxide, N-methylpyrrolidone, tetrahydrofuran, and so on. The coating method may include, but is not limited to, screen printing, spray coating, doctor blade methods, gravure coating, dip coating, silk screening, painting, and so on, depending on the viscosity of the composition.

The polymer electrolyte membrane may be any proton conductive polymer having a cation exchange group selected from the group consisting of a sulfonic acid group, a carboxylic acid group, a phosphoric acid group, a phosphonic acid group, and derivatives thereof, at its side chain.

Non-limiting examples of the polymer resin include at least one proton conductive polymer selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly (2,5-benzimidazole).

The following examples illustrate the present invention in more detail. However, it is to be understood that the present invention is not limited to these examples.

### EXAMPLE 1

Alumina was added into a cerium nitrate (Ce(NO₃)₃.6H₂O) aqueous solution. Herein, the amounts of alumina and cerium nitrate were 7.4 g and 5.30 g, respectively. Subsequently, Ni(NO₃)₂.6H₂O solution was added to the mixture. Herein, the mixture of alumina and cerium nitrate and the Ni(NO₃)₂-6H₂O solution were mixed to provide a mixing weight ratio of 12.70:0.0389.

The obtained mixture was calcinated at 500° C. to provide a NiO/CeO₂/Al₂O₃ compound.

1 mole of Cu(NO₃)₂.3H₂O (1M of Cu(NO₃)₂.3H₂O per 1000 g of water) solution was added to the mixture at a weight ratio of 4.98:9.1, and then the mixture was calcinated at 500° C.

### EXAMPLE 2

The same process as in Example 1 was performed except that cordierite was used instead of alumina.

### EXAMPLE 3

162.34 g of Cu(NO₃)₂.3H₂O was dissolved in 400 ml of water, and 500 ml of water was further added thereto to provide a Cu(NO₃)₂.3H₂O solution. To 10 ml of the solution, cerium nitrate (Ce(NO₃)₃.6H₂O) and Ni(NO₃)₂.6H₂O were added in amount of 5.2981 g and 0.0386 g.

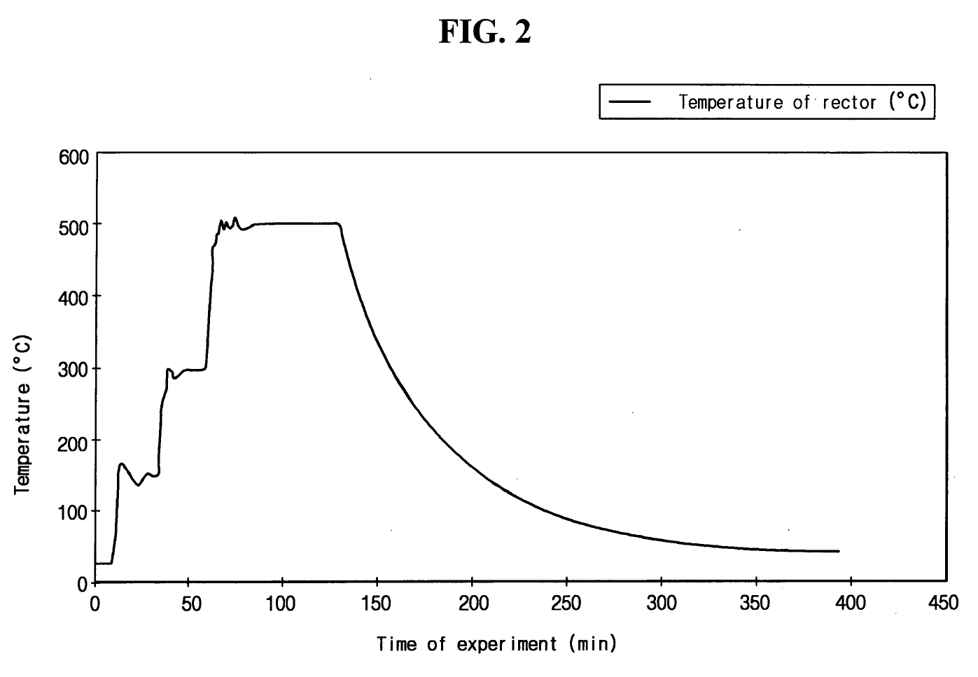

Then, 14.84 g of alumina (Al₂O₃) was added to the obtained solution. The mixture was heated and evaporated with agitation to provide an incorporated particle. The incorporated particle was put into a crucible and calcinated in a furnace at 500° C. under the heating temperature conditions shown in FIG. 2 to provide a carbon monoxide oxidizing catalyst.

### EXAMPLE 4

A carbon monoxide oxidizing catalyst was prepared in accordance with the same process as in Example 3 except that the amount of Ni(NO₃)₂.6H₂O was changed to 0.1543 g.

### EXAMPLE 5

A carbon monoxide oxidizing catalyst was prepared in accordance with the same process as in Example 3 except that the amount of Cu(NO₃)₂.3H₂O was changed to 1.3187 g, that of Ce(NO₃)₃.6H₂O) was changed to 5.7798 g, and that of Ni(NO₃)₂.6H₂O was changed to 1.6238 g.

### COMPARATIVE EXAMPLE 1

A carbon monoxide oxidizing catalyst was prepared according to the same procedures as in Example 3 except that Ni(NO₃)₂.6H₂O was not used.

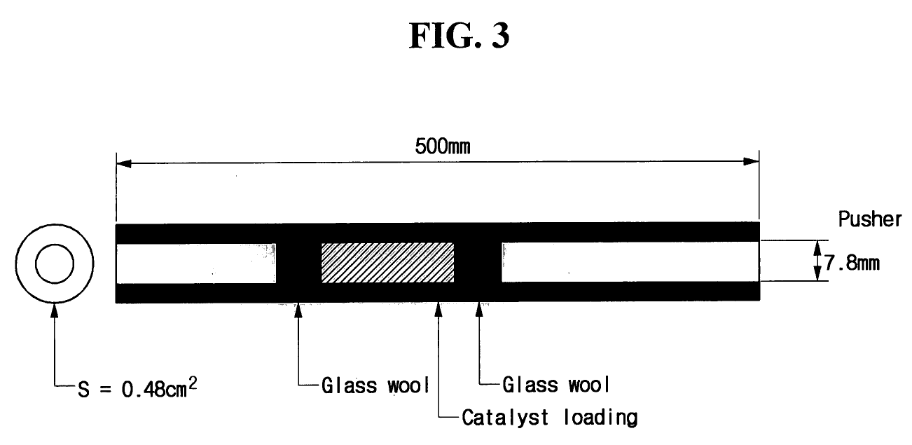

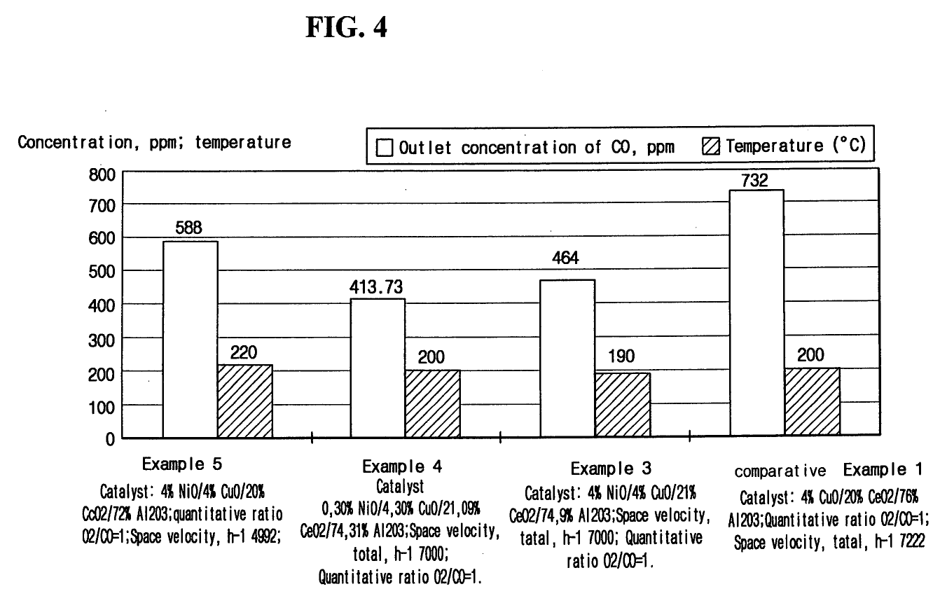

Carbon monoxide oxidizing catalysts according to Examples 3 thru 5 and Comparative Example 1 were measured to determine the CO exhausted amount by subjecting to a preferential oxidation (PROX) reaction with the reactor shown in FIG. 3. The results are illustrated in FIG. 4.
Reaction condition
Gas mixture flow rate from the gas cylinder: 1100 ml/min.
Air flow rate: 25 ml/min
Quantitative ratio of O₂/CO: 1
Loading amount of the catalyst in the reactor: 10 ml
Space velocity: 10000 h-1
Fluid speed reduction efficiency obtained from theoretical values: 1.38
Water: 0.429 ml/min.
Mixed gas composition: see following Table 1.
Fluid speed: 1690.6 ml/min

TABLE 1

| | Mixed gases including water and air |
|---|---|
| | Concentration (%) |
| CO₂ | 14.38 |
| H₂ | 39.23 |
| N₂ | 12.29 |
| CH₄ | 0.33 |
| CO | 0.31 |
| O₂ | 0.31 |
| Supply of water and steam | 33.16 |

As shown in FIG. 4, carbon monoxide oxidizing catalysts according to Examples 3 thru 5 lowered the CO concentration included in the exhausted gas compared to that of Comparative Example 1.

The carbon monoxide oxidizing catalyst for the reformer for the fuel cell system has very excellent carbon monoxide oxidizing activity. Thereby, it can decrease to a minute trace the amount of carbon monoxide generated while the hydrogen gas is generated by reforming the fuel. Accordingly, it is possible to prevent catalyst poisoning by carbon monoxide, and to improve the battery performance and the lifespan thereof.

While this invention has been described in connection with what is presently considered to be practical exemplary embodiments, it is to be understood that the invention is not limited to the disclosed embodiments, but rather it is intended to cover various modifications and equivalent arrangements included within the spirit and scope of the appended claims.

What is claim is:

1. A carbon monoxide oxidizing catalyst for a reformer of a fuel cell system comprising:
a carrier selected from the group consisting of alumina, cordierite, and combinations thereof; and
an active material including CeO₂, MO, and CuO, where M is a transition element which is supported on the carrier.

2. The carbon monoxide oxidizing catalyst of claim 1, wherein M is selected from the group consisting of Ni, Co, Fe, and combinations thereof.

3. The carbon monoxide oxidizing catalyst of claim 2, wherein M is Ni.

4. The carbon monoxide oxidizing catalyst of claim 1, wherein 0.1 to 2 wt % of MO is used.

5. The carbon monoxide oxidizing catalyst of claim 4, wherein the carbon monoxide oxidizing catalyst comprises 0.1 to 0.4 wt % of MO.

6. The carbon monoxide oxidizing catalyst of claim 1, wherein 10 to 30 wt % of CeO₂ is used.

7. The carbon monoxide oxidizing catalyst of claim 6, wherein 15 to 25 wt % of CeO₂ is used.

8. The carbon monoxide oxidizing catalyst of claim 1, wherein 1 to 10 wt % of CuO is used.

9. The carbon monoxide oxidizing catalyst of claim 8, wherein 2.5 to 5wt % of CuO is used.

10. The carbon monoxide oxidizing catalyst of claim 1, wherein the cordierite is modified with alumina.

11. A method of preparing a carbon monoxide oxidizing catalyst for a reformer of a fuel cell system, comprising the steps of:
mixing one of alumina and cordierite with a cerium compound solution;
adding the mixture to a transition element compound solution;
subjecting the mixture, including said one of alumina and cordierite, the cerium compound, and the transition element compound, to a first calcination to form a calcinated product;
adding a Cu compound solution to the calcinated product to form a mixture; and
subjecting the mixture to a second calcination.

12. The method of claim 11, wherein the cerium compound is at least one selected from the group consisting of ammonium cerium nitrate, cerium nitrate, cerium acetate, cerium chloride, and combinations thereof.

13. The method of claim 11, wherein the transition element compound is at least one selected from the group consisting of a transition element-containing nitrate, a transition element-containing acetate, a transition element-containing chloride, and combinations thereof.

14. The method of claim 11, wherein a mixing ratio of said one of alumina and cordierite and the cerium compound is 50 to 90 wt % and 50 to 10 wt %, respectively.

15. The method of claim 14, wherein the mixing ratio of said one of alumina and cordierite and the cerium compound is 80 to 75 wt % and 20 to 25 wt %, respectively.

16. The method of claim 11, wherein one of the first calcination and the second calcination is performed at 450 to 550° C.

17. The method of claim 11, wherein the Cu compound solution is added in an amount of 1 to 10 parts by weight based on 100 parts by weight of the cerium compound.

18. A fuel cell system, comprising:
a reformer which includes a reforming reaction part which generates hydrogen gas from a fuel through a catalyst reforming reaction using heat energy, and a carbon monoxide reducing part which reduces carbon monoxide concentration in the hydrogen gas through an oxidation reaction of the hydrogen gas with oxygen;
at least one electricity generating element for generating electrical energy by electrochemical reactions of the hydrogen gas and oxygen;
a fuel supplier for supplying the fuel to the reforming reaction part;
an oxidant supplier for supplying an oxidant to the carbon monoxide reducing part and said at least one electricity generating element, respectively; and
a cooler for cooling heat generated by the carbon monoxide reducing part by circulating the fuel supplied to the reforming reaction part to the carbon monoxide reducing part;
wherein the reformer further comprises a carrier selected from the group consisting of alumina, cordierite, and combinations thereof, and an active material including CeO₂, MO, and CuO, where M is a transition element which is supported on the carrier.

19. The fuel cell system of claim 18, wherein M is selected from the group consisting of Ni, Co, Fe, and combinations thereof.

20. The fuel cell system of claim 19, wherein M is Ni.

21. The fuel cell system of claim 18, wherein the carbon monoxide reducing part includes a carbon monoxide oxidizing catalyst which comprises 0.1 to 2 wt % of MO.

22. The fuel cell system of claim 21, wherein the carbon monoxide oxidizing catalyst comprises 0.1 to 0.4 wt % of MO.

23. The fuel cell system of claim 18, wherein the carbon monoxide oxidizing catalyst comprises 10 to 30 wt % of CeO₂.

24. The fuel cell system of claim 23, wherein the carbon monoxide oxidizing catalyst comprises 15 to 25 wt % of CeO₂.

25. The fuel cell system of claim 18, wherein the carbon monoxide oxidizing catalyst comprises 1 to 10 wt % of CuO.

26. The fuel cell system of claim 25, wherein the carbon monoxide oxidizing catalyst comprises 2.5 to 5 wt % of CuO.

27. The fuel cell system of claim 18, wherein cordierite is modified with alumina in forming the carrier of the reformer.
